(19) United States
(12) Patent Application Publication
(10) Pub. No.: US 2014/0131921 A1
(43) Pub. Date: May 15, 2014

(54) PROCESS FOR SELECTIVE LASER MELTING AND SYSTEM FOR CARRYING OUT SAID PROCESS

(71) Applicants: Yves Küsters, Berlin (DE); Friedrich Lupp, München (DE); Olaf Rehme, Hamburg (DE); Martin Schäfer, Berlin (DE)

(72) Inventors: Yves Küsters, Berlin (DE); Friedrich Lupp, München (DE); Olaf Rehme, Hamburg (DE); Martin Schäfer, Berlin (DE)

(73) Assignee: SIEMENS AKTIENGESELLSCHAFT, München (DE)

(21) Appl. No.: 14/110,650

(22) PCT Filed: Apr. 2, 2012
(86) PCT No.: PCT/EP2012/055941

§ 371 Date: Dec. 20, 2013

(30) Foreign Application Priority Data
Apr. 8, 2011 (DE) 10 2011 007 067.2

(51) Int. Cl. B29C 67/00

(52) U.S. Cl. CPC B29C 67/00
USPC 264/400; 425/174.4

(57) ABSTRACT

A component is manufactured by selective laser melting by a laser having an intensity profile set largely constant by a diffractive optical element, so that the treatment surface which has occurred as a result of this profile is melted uniformly on the surface of the component. Thermal load peaks, such as occur due to an intensity maximum of an unshaped laser, can therefore be advantageously avoided. Moreover, the treatment surface may, for example, have a square shape, so that, in the case of rectangular components, it becomes simpler to produce the corners of the cross section to be manufactured. Overall, as a result, components having improved surface quality can be produced. The system is equipped with suitable optics for generating the intensity profile described.

### CROSS REFERENCE TO RELATED APPLICATIONS

This application is the U.S. national stage of International Application No. PCT/EP2012/055941, filed Apr. 2, 2012 and claims the benefit thereof. The International Application claims the benefit of German Application No. 10 2011 007 067.2 filed on Apr. 8, 2011, both applications are incorporated by reference herein in their entirety.

### BACKGROUND

Described below is a process for producing a component by selective laser melting, in which a laser beam is directed onto that region of the component being manufactured which is just to be produced and particles of the component material are melted locally there. Moreover, a system for selective laser melting has a construction platform for a workpiece to be produced, and to a laser which can be directed onto the construction platform.

A process of the type initially specified and a system suitable for carrying out this process are generally known, for example, from U.S. Pat. No. 7,601,422 B2. The system has a construction platform which can be charged in layers with a powder of the component material. A laser is directed via a mirror onto the in each case formed powder surface where the particles of the powder can be melted locally. Data relating to the geometry of the component to be manufactured are processed in the system, so that this component arises in layers in the powder bed on the construction platform. The scanning of the surface of the powder bed by the laser beam gives rise, as a consequence of the principle used, to a grid-like or stepped surface in the component. The surface quality can be influenced by setting the parameters of the laser, but, because of the principle used, cannot be balanced completely.

### SUMMARY

Described below are a process for producing a component by selective laser melting and a system, suitable for the specified laser melting, by which the surface quality of the component manufactured can be improved, as compared with known processes.

In the process the laser beam is shaped, in particular widened, by an optical element in such a way that, in at least one direction transverse to the beam propagation direction, equalization of the intensity profile of the laser light in that region of the component being manufactured which is just to be produced is obtained, that is to say a “top hat profile”, as it is known, is produced. In this respect, it should be noted that the intensity profile of a laser beam has per se an intensity distribution which can be described by a bell-shaped profile (Gaussian distribution). This means that the intensity maximum lies at the center of the laser beam and the intensity decreases toward the margins of the laser beam. As a result, when the powder bed is being melted, a temperature maximum is reached in the middle of the laser spot on the surface of the powder bed, the temperature decreasing toward the margin and not being sufficient at the margin to melt the particles. Consequently, particularly at the margin of the component cross section currently to be manufactured, problems are caused on the surface of the powder bed. To be precise, the laser spot has to dwell at the margin of the cross section until the marginal particles of the component to be manufactured have been melted. However, at this time point, too large an amount of energy has already been delivered in the vicinity of the margin, to be precise where the intensity maximum of the laser beam is located. The process is therefore difficult to control, particularly at the margin of the cross section, and there is a high risk that the surface quality of the component is thereby impaired.

The process addresses the shaping of the laser beam to bring about equalization of the intensity profile. This can take place, in particular, by known beam shaping elements, that is to say shaping distributes the maximum light intensity to a larger surface area of the laser spot, while at the same time reducing the intensity maximum. Within this area, a uniformly intensive supply of energy to the powder bed is advantageously brought about, with the result that unwanted temperature peaks in the melting bath can advantageously be avoided.

Beam shaping is advantageously designed such that the size and shape of the area can be varied during processing. A reduction in the process speed can thus be achieved, without loss of flexibility with regard to the possible structural sizes. In particular, by a top hat profile, even smaller structures can be produced than with bell-shaped intensity distribution.

It should be noted that the component produced has surface fractions which contain a plurality of the component layers individually produced. In these surface areas, the surface quality can be improved, in particular, in that the steps necessarily occurring are formed more regularly by the management of the process, so that the optimum in surface quality (with some stepping of the surface remaining) is achieved here. In surface fractions of the component which lie exactly perpendicular to the beam direction of the laser beam, an improvement in surface quality can likewise be achieved. This is possible in that, by equalizing the intensity profile of the laser spot on the powder bed, there can be less overlapping of the tracks made by the laser on the component cross-sectional surface to be manufactured, and consequently, for example, multiple melting of the surface is prevented.

An additional advantage in managing the process is also afforded in that the widening of the introduced radiation energy to a larger surface portion of the laser spot also reduces the formation of inherent stresses in the component. As a result, secondary treatments of the component for the breakdown of stresses (for example, heat treatments) can advantageously be curtailed or even be dispensed with entirely in the production process.

According to an advantageous refinement of the process, there is provision whereby the laser beam is shaped by a diffractive optical element which brings about the equalization of the intensity profile over a defined treatment surface in the region to be produced. Diffractive optical elements, also designated as “refractive beam shapers”, are known per se and are offered, for example, by the company Newport. Diffractive optical elements, when used, have the advantage that a largely uniform intensity profile can be set over a defined surface. In this case, shapes with different surfaces, such as, for example, square or round surfaces, can be produced. According to a particular refinement of the process, it is possible, for example, to provide a treatment surface which is approximately rectangular, in particular square. As a result, in particular, components, the cross-sectional surface of which has straight edges and, in particular, also right-angled corners, can advantageously be readily manufactured effectively. The widened laser can advantageously be guided directly, by one of the side edges of the treatment surface, along the margin of the cross-sectional surface to be manufactured. In this case, a uniform introduction of energy occurs in the marginal region of the cross section to be manufactured, with the result that the quality of the component arising can advantageously be further improved. Particularly in the corner of the cross section, the result of using a rectangular treatment surface is that this can be moved right into the corner and a uniform introduction of energy in the region of the corner can therefore be ensured.

It is also advantageous if the treatment surface is approximately oval, in particular round. By generating a treatment surface with this configuration, in particular, cross-sectional surfaces of the component to be manufactured which have a curved outer contour can be produced. The laser can then be guided along the curved outer contour and at the same time always touch the outer contour tangentially, irrespective of the angular position which that subregion of the outer contour which is to be produced just has in the plane of the powder bed.

In an embodiment of the process , depending on the configuration of the cross-sectional surface to be produced, there can be a change between a rectangular, in particular square, treatment surface and an oval, in particular round, treatment surface. This is possible when different refractive optical elements can be used, that is to say when these can be exchanged. Depending on which contour regions just have to be manufactured, the more suitable treatment surface is then selected. It is advantageous if the intensity of the laser light within the treatment surface deviates from a stipulated desired value by less than 10%, particularly, less than 5%. In this case, a highly uniform distribution of the introduction of energy advantageously occurs in the region.

The system has optics which shape the intensity profile of the laser light are arranged in the beam path of the laser, the intensity profile generated lying in the region of the component to be produced on the construction platform. It can thereby be ensured that the treatment surface already mentioned can be produced in the region where the component is to be manufactured in layers above the construction platform. In this case, the advantages already mentioned can be achieved.

According to an advantageous form of the system, there is provision whereby the optics are designed as a diffractive optical element. Comparatively constant light intensities can thereby be generated on treatment surfaces having any geometrical shapes. In particular, it is possible that the diffractive optical element performs a widening of the beam into a rectangular, in particular square, treatment surface. Widening of the beam into an oval, in particular round, treatment surface is also possible. The advantages of these types of treatment surfaces in the manufacture of different component cross sections have already been explained.

In an embodiment of the system, the beam path of the laser can be guided selectively through one of a plurality of diffractive optical elements, a treatment surface with a different geometry being selectable by each diffractive optical element. Such a system may be implemented, for example, in that a type of bayonet or turret is provided underneath the laser and has different diffractive optics which can be brought in each case into the beam path of the laser. The diffractive optics can then selectively provide, for example, a square treatment surface, a round treatment surface or else other treatment surfaces.

In an embodiment of the system, in addition to the diffractive optics, further optical components are provided, by which the size of the treatment surface can be set, in particular in combination with the possibility of an automatic change of different diffractive optics in the beam path.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a cross sectional view illustrating the essential elements of an exemplary embodiment of the system for laser melting, and

FIGS. 2 and 3 are perspective views exemplary embodiments of the process.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

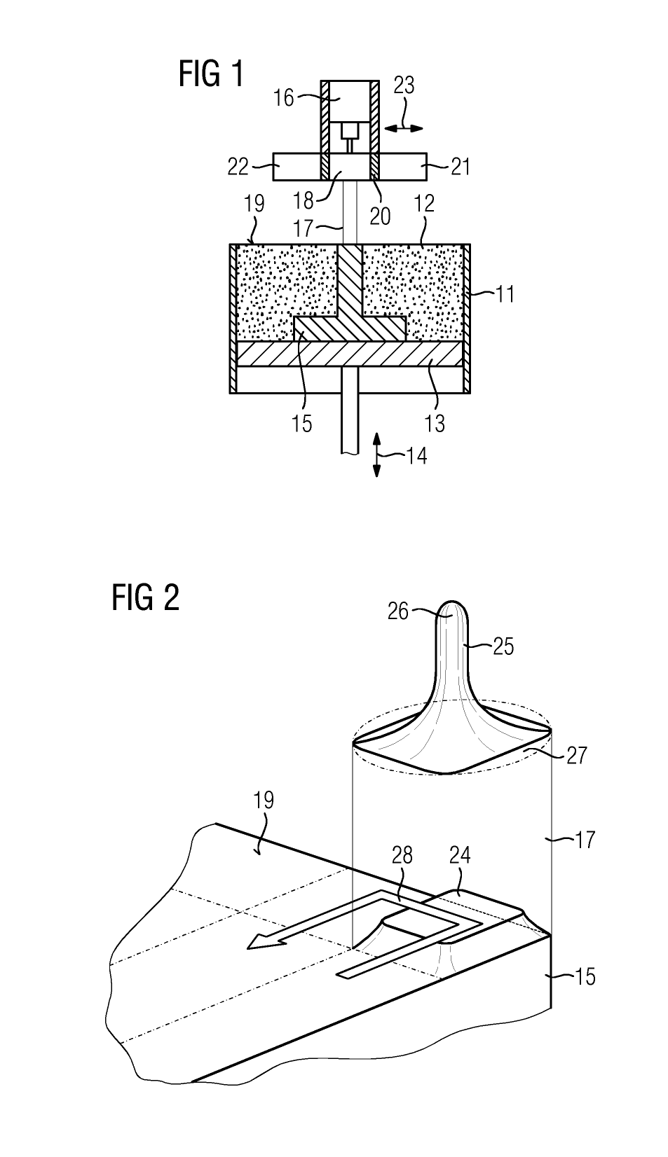

A system for selective laser melting according to FIG. 1 is illustrated only in its constituents which are essential. A container 11, in which a powder bed 12 of particles can be stored, can be seen. The container has as a bottom a construction platform 13 which can be raised and lowered in the direction of an indicated double arrow 14 by a drive, not illustrated.

A component 15 can be manufactured in layers in the powder bed 12 in that a laser 16 generates a laser beam 17. This is conducted through optics 18 which have a refractive optical element in a way not illustrated in any more detail. As can be seen, the laser beam is widened by the optics. This causes the particles to melt on the surface 19 of the powder bed, as a result of which the component 15 is formed in layers.

The optics 18 are part of a bayonet 20 in which optics 21 and optics 22 are also accommodated. With the aid of the bayonet, the different optics 18, 21, 22 can be exchanged by a drive, not illustrated. Each optics generates beam widening with a different characteristic, so that this can be adapted to the application of the component 15 currently to be manufactured. The laser 16 and the optics 18 (or 21, 22) can be moved in the direction of the indicated double arrow and perpendicularly to the drawing plane, in order to sweep over the entire surface of the powder bed 12, depending on how the geometry of the component 15 to be manufactured is formed.

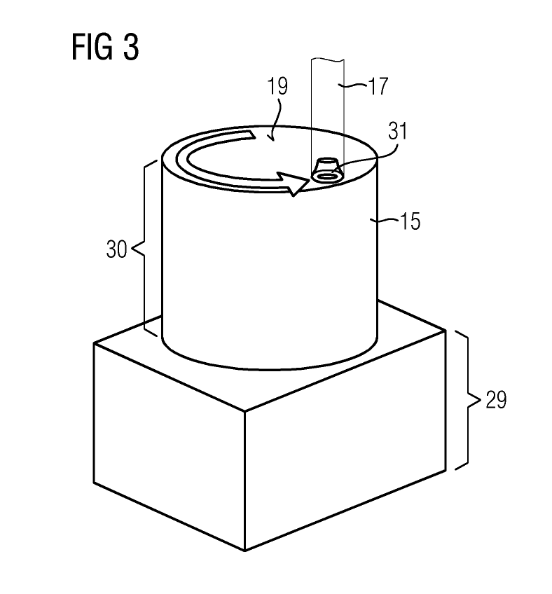

FIG. 2 illustrates a process for producing a rectangular component 15. The surface 19 of the powder bed is illustrated as a cutout. What can be seen, furthermore, is that the laser beam 17 has been widened into a rectangular treatment surface 24, a diffractive optical element being used which generates over the treatment surface 24 a largely uniform intensity profile which is indicated by a flat plateau. For comparison, the intensity profile of the laser beam before passage through the diffractive optical element is illustrated above the treatment surface 24. A bell-shaped form of the intensity profile 25 of the laser beam is shown, as is characteristic of laser beams. This has a highly pronounced maximum 26 and then quickly falls outwardly to substantially lower intensity values. The dashed and dotted round base 27 indicates that this intensity profile 25 of the laser beam is of rotationally symmetrical form. There is a different behavior in the case of the intensity profile which is generated by the refractive optics and which makes available the treatment surface 24. This intensity profile has a square plan.

The square plan of the treatment surface 24 results in a movement pattern of the laser 17 which is indicated by the arrow 28. The dashed and dotted lines on the surface 19 indicate the grid in which the treatment surface 24 can be guided over the surface.

The manufacture of another component 15 is indicated in FIG. 3. It becomes clear that this component has different regions, and in this case the lower part 29 can advantageously be manufactured by a process designed according to FIG. 2. The part 30, which is cylindrical, has a cross-sectional surface without corners, so that this can advantageously be manufactured in the surface 19 of the powder bed by a round treatment surface 31. Here, too, refractive optics are used which have an intensity profile with a largely constant intensity within the treatment surface. The component 15 according to FIG. 3 can be manufactured especially advantageously by a system according to FIG. 1 in which a turret 20 with a plurality of optics 21, 22, 18 is provided.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-8. (canceled)

9. A process for producing a component by selective laser melting, comprising:
directing a laser beam onto a region of a treatment surface of the component, with equalization of an intensity profile of the laser beam in the region of the treatment surface, to melt particles of component material in the region, at least a first portion of the treatment surface being substantially rectangular and the laser beam being widened by an optical element in at least one direction transverse to a beam propagation direction.

10. The process as claimed in claim 9, wherein the first portion of the treatment surface is substantially square.

11. The process as claimed in claim 10, wherein the equalization of the intensity profile over the region of the treatment surface is obtained by conducting the laser beam through a diffractive optical element +15.

12. The process as claimed in claim 11, wherein a second portion of the treatment surface is substantially oval.

13. The process as claimed in claim 11, wherein a second portion of the treatment surface is substantially round.

14. The process as claimed in claim 11, wherein said directing directs the laser beam along a beam path and the component has a processing surface with a variable size set by optical components in the beam path.

15. The process as claimed in claim 14, further comprising maintaining an intensity of the laser beam within the treatment surface within a deviation range of a stipulated desired value that is less than 10%,

16. The process as claimed in claim 14, wherein the deviation range is less than 5%.

17. A system for selective laser melting of a workpiece, comprising:
a construction platform supporting the workpiece;
a laser which can be directed onto the construction platform; and
optics, including a diffractive optical element shaping an intensity profile of laser light in a beam path of the laser, the intensity profile generated in a region of a component to be produced from the workpiece on the construction platform, the diffractive optical element performs beam shaping into a treatment surface that is at least partially rectangular.

18. The system as claimed in claim 17, wherein the rectangular treatment surface is substantially square.

19. The system as claimed in claim 17, wherein the optics include
a plurality of diffractive optical elements; and
means for directing the beam path of the laser selectively through one of the plurality of diffractive optical elements to form the treatment surface with different geometry by each of the diffractive optical elements.
